(19) United States
(12) Patent Application Publication
(10) Pub. No.: US 2008/0131359 A1
(43) Pub. Date: Jun. 5, 2008

(54) METHOD AND DEVICE FOR THE SYNTHESIS OF HYDROGEN FROM SUBSTANCES CONTAINING GLYCERIN

(75) Inventors: Axel Behrens, Muenchen (DE); Wibke Korn, Krailing (DE); Pavel Masek, Muenchen (DE); Anton Wellenhofer, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 11/947,582

(22) Filed: Nov. 29, 2007

(30) Foreign Application Priority Data
Nov. 30, 2006 (DE) 10 2006 056 641.6

(51) Int. Cl. C01B 3/22

(52) U.S. Cl. 423/648.1; 422/187

(57) ABSTRACT

A method for producing a hydrogen product from a starting material containing glycerin as well as a device for conducting the method is disclosed. An intermediate product containing hydrogen and carbon monoxide is produced from the starting material containing glycerin by the separation of undesired substances and at least the pyrolysis of the glycerin, which intermediate product subsequently undergoes a hydrogen separation, where the intermediate product is not treated by reforming before hydrogen separation.

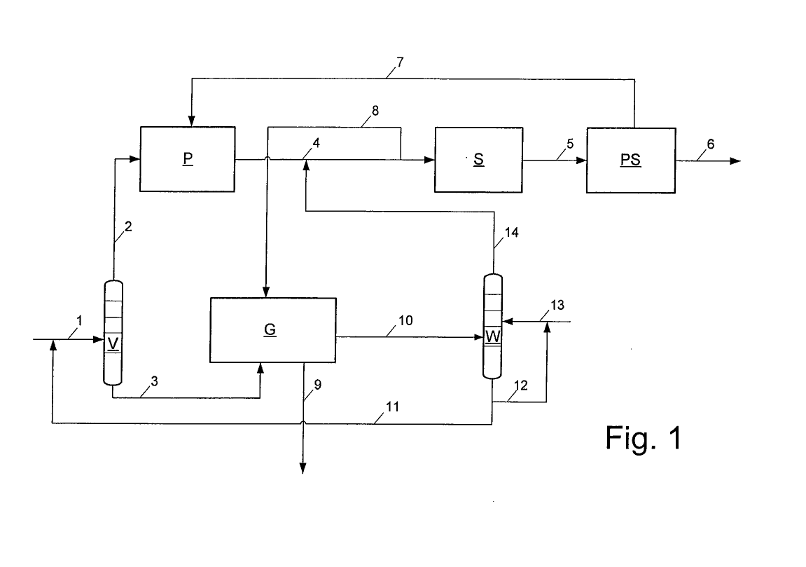

This application claims the priority of German Patent Document No. 10 2006 056 641.6, filed Nov. 30, 2006, the disclosure of which is expressly incorporated by reference herein.

### BACKGROUND AND SUMMARY OF THE INVENTION

The invention relates to a method for producing a hydrogen product from a starting material containing glycerin as well as a device for conducting the method.

In an effort to reduce carbon dioxide emissions into the earth's atmosphere or at least to keep them from increasing further, and as alternatives to dwindling crude oil and natural gas reserves, future sources of energy will increasingly be generated from renewable raw materials. In accordance with an EU Directive, these types of energy sources are supposed to cover a minimum of 5.75% of the fuel demand in the European Union by the year 2010. Biodiesel plays a prominent role in this case and nowadays it is already being added in a concentration of up to five percent to the diesel fuel that is available at German gas stations.

Biodiesel is a standardized fuel, which is obtained primarily from canola oil, but also from other vegetable oils and fats. Vegetable oils and fats are made up of triglycerides, i.e., fatty acids which are each triply bonded to glycerin. The result of this structure is that vegetable oils and fats are viscous to solid at normal ambient temperatures, i.e., have a much higher viscosity than the fuels for which a commercially available diesel engine is designed. Vegetable oils and fats behave differently during the injection process, and combustion is also not as clean. Engine-related measures to compensate for these disadvantages, such as preheating the vegetable oil, are only imperfect.

Biodiesel is produced from vegetable oils and fats by replacing the glycerin with methanol. Its viscosity corresponds to that of commercially available diesel fuel, which is the reason why it is also able to be burned without a problem in diesel engines that have not been modified.

The glycerin separated from the vegetable oils and fats during the production of biodiesel is not extracted in a pure form, rather it occurs as part of mixtures containing large quantities of impurities in addition to the glycerin. This type of mixture is for example so-called raw glycerin, which has a glycerin content of 80-85%, but also contains in still larger quantities water and salts as well as residual matter from the production process. According to the prior art, raw glycerin is purified in laborious process steps via vacuum distillation, deodorizing and filtration until it satisfies the strict requirements of the European Pharmacopeia and can be sold to the pharmaceutical industry as pharmaceutical-grade glycerin with a purity of at least 99.5%. Currently, the entire quantity of glycerin generated in the production of biodiesel can be utilized in this manner. With the foreseeable expansion of the production of biodiesel, this will become increasingly difficult in the future, however, so that it will be necessary to search for other means of utilizing the raw glycerin.

As a result, the objective of the present invention is disclosing a method of the generic kind, which makes it possible to direct byproducts containing glycerin generated in the production of biodiesel to economic utilization.

This objective is attained by the inventive method in that an intermediate product containing hydrogen and carbon monoxide is produced from the starting material containing glycerin by the separation of undesired substances and at least the pyrolysis of the glycerin, which intermediate product subsequently undergoes a hydrogen separation, wherein the intermediate product is not treated by reforming before hydrogen separation.

One embodiment of the inventive method provides for the separation of undesired substances, which were already present in the starting material and/or produced by conducting the inventive method, and the pyrolysis of glycerin being performed simultaneously in one step of the process.

Another embodiment of the method in accordance with the invention provides for an intermediate product to be obtained from the starting material in at least two successive steps of the process, wherein undesired substances are separated in each of the steps of the process and/or glycerin is transformed by pyrolysis.

Preferred embodiments of the inventive method provide for the hydrogen separation to be conducted using pressure swing adsorption (PSA) or in a membrane method, wherein, besides a hydrogen product, at least a residual gas flow is produced.

The residual gas produced during the hydrogen separation ordinarily also contains combustible components such as H₂, CO and hydrocarbons in addition to inert constituents (e.g., CO₂, H₂O). In order to use the chemical energy contained in the residual gas, another embodiment of the inventive method provides for the residual gas to combust and the energy released during combustion to be used to cover the demand for energy within the method. The released energy is preferably used for preheating the starting material and/or for separation of the undesired substances from the starting material and/or for the pyrolysis of glycerin.

In order to increase the hydrogen yield, an expedient embodiment of the method in accordance with the invention provides for the intermediate product produced from the starting material by the separation of undesired substances and at least the pyrolysis of the glycerin to undergo a water gas shift reaction before hydrogen separation, during which the carbon monoxide contained in the intermediate product is preferably completely transformed with the participation of water into hydrogen and carbon monoxide. If the intermediate product does not contain a sufficient amount of water in order to achieve the desired CO reaction, the water content in the intermediate product is increased by admixing water before the water gas shift reaction to a value which is adequate to cover the water requirement for the reaction. The invention provides further that the water gas shift be performed as a low temperature water gas shift and/or as a medium temperature water gas shift and/or as a high temperature water gas shift.

The intermediate product produced from the starting material by the separation of undesired substances and at least the pyrolysis of the glycerin may still contain undesired constituents, which cause interference in the subsequent process steps (water gas shift, hydrogen separation), such as, e.g., poisoning of catalysts and/or blocking of membranes or pipelines for example. As a result, a development of the method in accordance with the invention provides for the intermediate product to undergo a cleaning before hydrogen separation or before the water gas shift reaction, in which the undesired constituents are removed from the intermediate product.

In order to separate the undesired substances present in the starting material, according to the invention, the starting material preferably undergoes a distillation and/or a thermal drying and/or a filtering via active charcoal and/or a membrane and/or chromatography and/or an ion exchange.

What is meant by thermal drying in this case is that the starting material is fed into a thermal drying device and undergoes a thermal treatment there. Volatile constituents, such as water and glycerin, are vaporized and form, in some circumstances with other gaseous substances, a gas fraction, while solid matter, such as salts, are transformed into a largely water-free solid matter fraction. The solid matter and gas fractions are then withdrawn in a largely separated manner from the thermal drying device, which is equipped for this purpose with a suitable device for separating dust and gas, such as a gravitational separator and/or a centrifugal cyclonic separator and/or a filtering device and/or a water washer.

With sufficiently high temperatures, glycerin is thermally disintegrated, i.e., pyrolyzed. As a result, the inventive method provides in a further development that the thermal drying of the starting material be conducted at temperatures at which at least a partial transformation of the glycerin contained in the starting material occurs through pyrolysis. Depending upon how much of the glycerin is pyrolyzed during thermal drying, the gas fraction will undergo further pyrolysis following thermal drying.

An advantageous embodiment of the inventive method provides for the heat required for the thermal drying of the starting material to be extracted from a hot gas flow whose temperature lies between 100 and 1,000° C., preferably between 100 and 250° C., and in which it is preferably a partial flow of the intermediate product obtained from the starting material by the separation of undesired substances and at least the pyrolysis of glycerin. If the heat is conveyed in an indirect heat exchange from this partial flow to the starting material, then the cooled partial flow is advantageously fed back again and supplied to the intermediate product flow.

Fluidized-bed granulators and/or fluidized-bed dryers and/or drum-type dryers and/or turbulent-layer dryers and/or suspension dryers and/or paste dryers are preferably used for the thermal drying of the starting material.

Variations of the inventive method provide for the pyrolysis to be performed by supplying water and/or steam and/or an oxidizing agent, wherein the oxidizing agent is air or oxygen-enriched air or oxygen.

Depending upon the method that is selected for separating undesired substances from the starting material, an aqueous mixture (aqueous waste) can be generated during the execution of the inventive method, in which mixture the separated substances are present in a dissolved and/or suspended form, and which cannot be used materially without further treatment. The aqueous waste represents a waste material, which must be supplied for dumping as special waste. In order to keep dumping costs low, efforts are made to keep the volume of waste to be dumped as small as possible. As a result, an embodiment of the method in accordance with the invention provides for the aqueous waste to undergo a treatment in which the volume of waste to be dumped is reduced. The aqueous waste preferably undergoes drying in a thermal drying device, wherein a largely water-free solid matter fraction and a gas fraction are produced. In the most favorable case, the solid matter fraction that is obtained in this manner can be utilized economically (e.g., as a fertilizer) so that the volume of waste to be dumped drops to zero.

An advantageous embodiment of the inventive method provides for the heat required for the thermal drying of the aqueous waste to be extracted from a hot gas flow whose temperature lies between 100 and 1,000° C., preferably between 100 and 250° C., and in which it is preferably a partial flow of the intermediate product obtained from the starting material by the separation of undesired substances and at least the pyrolysis of glycerin. Because of the heat that is released by the hot gas flow to the aqueous waste, volatile constituents are conveyed from the aqueous waste to the gas phase, thereby producing a gas fraction and a largely water-free solid matter fraction, which, depending upon the drying method used, is present as a granulate or a powder for example.

If the hot gas flow used for the thermal drying of aqueous waste is a hot partial flow of the intermediate product obtained from the starting material by the separation of undesired substances and at least the pyrolysis of glycerin and if the heat is conveyed in a direct heat exchange to the aqueous waste being dried, then a development of the method in accordance with the invention provides for the gas fraction produced during drying to preferably undergo a water washing in a water washing device and then to be fed back to the intermediate product flow. The charged wash water is extracted from the water washing device in an expedient manner and admixed with the starting material containing glycerin.

Fluidized-bed granulators and/or fluidized-bed dryers and/or drum-type dryers and/or turbulent-layer dryers and/or suspension dryers and/or paste dryers are preferably used for the thermal drying of the aqueous waste.

The invention further relates to a device for conducting the method in accordance with the invention.

In terms of the device, the stated objective is attained in that it is comprised of a pyrolysis device, in which an intermediate product containing hydrogen and carbon monoxide can be produced from the starting material by the separation of impurities and pyrolysis of the glycerin contained in the starting material, and at least one device for hydrogen separation that is downstream from the pyrolysis device, in which hydrogen contained in the intermediate product can be separated, wherein a device for gas reforming is not arranged between the pyrolysis device and the device for hydrogen separation.

Preferred embodiments of the inventive device provide for the device for hydrogen separation to be designed as a pressure swing adsorption (PSA) or as a membrane method.

In order to increase the hydrogen yield, an expedient embodiment of the device in accordance with the invention provides for a device for conducting a water gas shift reaction to be arranged in front of the device for hydrogen separation, in which the carbon monoxide contained in the intermediate product produced from the starting material by the separation of undesired substances and at least the pyrolysis of glycerin can be transformed with the participation of water preferably completely into hydrogen and carbon monoxide. The device for conducting a water gas shift reaction is preferably a low temperature water gas shift reactor and/or a medium temperature water gas shift reactor and/or a high temperature water gas shift reactor.

The intermediate product produced from the starting material by the separation of undesired substances and at least the pyrolysis of the glycerin may still contain undesired constituents, which cause interference in the subsequent process steps (water gas shift, hydrogen separation), such as, e.g., poisoning of catalysts and/or blocking of membranes or pipelines for example. As a result, a development of the device in accordance with the invention provides for a cleaning device to be arranged in front of the hydrogen separation or in front of the device for conducting a water gas shift reaction, in which undesired constituents can be separated from the intermediate product.

A preferred embodiment of the inventive device provides for the pyrolysis device to be comprised of a thermal drying device, in which a gas fraction and a largely water-free solid matter fraction can be produced from the starting material, wherein glycerin present in the gas fraction is at least partially pyrolyzed due to the temperatures prevailing in the thermal drying device. The thermal drying device expediently includes a suitable device for the separation of dust from the gas fraction so that a largely dust-free intermediate product can be produced. The thermal drying device is preferably a fluidized-bed granulator and/or a fluidized-bed dryer and/or a drum-type dryer and/or a turbulent-layer dryer and/or a suspension dryer and/or a paste dryer. These types of thermal drying devices have been known to the person skilled in the art for years and are commercially available.

Another preferred embodiment of the inventive device provides for the pyrolysis device to include a cleaning device and a downstream pyrolysis reactor, wherein a pyrolysis feedstock can be produced in the cleaning device from the starting material by the separation of impurities, which can be transformed into an intermediate product by pyrolysis in the pyrolysis reactor. According to the invention, the cleaning device is preferably embodied as a vacuum distillation device and/or a thermal drying device and/or a filtering device with active charcoal or a membrane and/or a chromatography device and/or an ion exchanger.

A preferred variation of the device in accordance with the invention provides for a device for reducing the water content of an aqueous mixture (aqueous waste) that is no longer materially utilizable that is generated during the cleaning of the starting material containing glycerin. This device is preferably a thermal drying device such as, e.g., a fluidized-bed granulator and/or a fluidized-bed dryer and/or a drum-type dryer and/or a turbulent-layer dryer and/or a suspension dryer and/or a paste dryer. These types of thermal drying devices have been known to the person skilled in the art for years and are commercially available. The thermal drying device is expediently designed such that a largely water-free solid matter fraction and a largely dust-free gas fraction can be produced from the aqueous waste.

If the thermal drying device is a device in which energy can be supplied to the aqueous waste to be dried in direct contact with a hot partial flow of the intermediate product obtained from the starting material by the separation of undesired substances and at least the pyrolysis of glycerin, then an advantageous embodiment of the inventive device provides for a water washing device, into which the gas flow charged with dust that is exiting from the thermal drying device can be fed and be freed of dust there by water washing, before it is fed back to the intermediate product flow. The charged wash water can be withdrawn from the water wash and admixed with the raw glycerin in an expedient manner.

### BRIEF DESCRIPTION OF THE DRAWING

The FIGURE is a schematic illustration of an embodiment of a method and device in accordance with the principles of the present invention.

### DETAILED DESCRIPTION OF THE DRAWING

The present exemplary embodiment relates to an installation for producing a product gas containing predominantly hydrogen, wherein raw glycerin from biodiesel production is used as a feedstock, which is comprised of approx. 85% glycerin, but also contains in still larger quantities water and salts as well as residual matter from the production process.

The raw glycerin is fed to the vacuum distillation device V via line 1, where it is separated into the two material flows 2 and 3. Then material flow 2, which is comprised almost exclusively of glycerin, is fed to the autothermal pyrolysis reactor P as feedstock and transformed there to a pyrolysis product comprised predominantly of hydrogen and carbon monoxide. The pyrolysis product is withdrawn from the pyrolysis reactor P via line 4 and supplied to the shift reactor S. A shift gas containing predominantly hydrogen is withdrawn via line 5 from the shift reactor S, in which the predominant portion of the carbon monoxide is transformed with water in a water gas shift reaction to carbon dioxide and hydrogen, and the shift gas is fed to pressure swing adsorption (PSA), where the hydrogen contained in the shift gas is separated with a high yield (>90 mol %). The separated hydrogen having a purity of more than 99% is supplied further as a hydrogen product via line 6, while the residual gas flow 7 containing H₂ and CO is used to fire the pyrolysis reactor P.

The material flow 3 from the vacuum distillation device V, which is comprised predominantly of water and salts as well as residual substances from biodiesel production, is fed to the granulator G and dried there by means of the hot material flow 8, which branches off from the pyrolysis product flow 4 before the shift reactor S. The salts and other solid matter contained in the material flow 3 are transformed into granulate and withdrawn from the granulator G via line 9. A material flow comprised predominantly of gases and vapors, but also containing solid matter in the form of dust, is supplied via line 10 to the water washing device W and cleaned there. A portion of the charged wash water from the water washing device W is withdrawn via line 11 and introduced jointly with the raw glycerin to the vacuum distillation device V via line 1, while the other portion 12 is mixed with free water 13 and fed back into the water washing device W as wash water. A material flow comprised predominantly of pyrolysis gas and water vapor is withdrawn from the water washing device W via line 14 and supplied to the pyrolysis product 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a hydrogen product from a starting material containing glycerin, wherein an intermediate product containing hydrogen and carbon monoxide is produced from the starting material containing glycerin by a separation of undesired substances and at least a pyrolysis of the glycerin, which intermediate product subsequently undergoes a hydrogen separation, wherein the intermediate product is not treated by reforming before the hydrogen separation.

2. The method according to claim 1, wherein the separation of undesired substances, which were already present in the starting material and/or produced in the method, and the pyrolysis of the glycerin are performed simultaneously in one step of the method.

3. The method according to claim 1, wherein the intermediate product is obtained from the starting material in at least two successive steps of the method, wherein undesired substances are separated in each of the steps of the method and/or glycerin is transformed by pyrolysis.

4. The method according to claim 1, wherein the hydrogen separation is conducted using pressure swing adsorption (PSA) or in a membrane method, wherein, besides the hydrogen product, at least a residual gas flow is produced.

5. The method according to claim 1, wherein a residual gas produced during the hydrogen separation combusts and energy released during combustion is used to as energy within the method.

6. The method according to claim 1, wherein the intermediate product undergoes a water gas shift reaction before hydrogen separation, during which the carbon monoxide contained in the intermediate product is completely transformed with water into hydrogen and carbon monoxide.

7. The method according to claim 1, wherein the intermediate product undergoes a cleaning before the hydrogen separation or before a water gas shift reaction, in which undesired constituents are removed from the intermediate product.

8. The method according to claim 1, wherein the pyrolysis is performed by supplying water and/or steam and/or an oxidizing agent, wherein the oxidizing agent is air or oxygen-enriched air or oxygen.

9. The method according to claim 1, wherein the undesired substances present in the starting material are separated by distillation and/or thermal drying and/or filtering via active charcoal and/or a membrane and/or chromatography and/or an ion exchange.

10. The method according to claim 9, wherein the thermal drying of the starting material is conducted at temperatures at which at least a partial transformation of the glycerin contained in the starting material occurs through pyrolysis.

11. The method according to claim 1, wherein an aqueous mixture that is generated during the separation of undesired substances from the starting material, in which mixture separated substances are present in a dissolved and/or suspended form, undergoes drying in a thermal dying device, wherein a largely water-free solid matter fraction and a gas fraction are produced.

12. A device for producing a hydrogen product from a starting material containing glycerin, comprising a pyrolysis device, in which an intermediate product containing hydrogen and carbon monoxide is produceable from the starting material by separation of undesired substances and pyrolysis of the glycerin contained in the starting material, and a device for hydrogen separation that is downstream from the pyrolysis device, in which hydrogen contained in the intermediate product is separable, wherein a device for gas reforming is not arranged between the pyrolysis device and the device for hydrogen separation.

13. The device according to claim 12, wherein the device for hydrogen separation is designed to perform a pressure swing adsorption (PSA) or a membrane method.

14. The device according to claim 12, wherein a device for conducting a water gas shift reaction is arranged in front of the device for hydrogen separation, in which the carbon monoxide contained in the intermediate product produced from the starting material by the separation of undesired substances and the pyrolysis of glycerin is transformable with water completely into hydrogen and carbon monoxide.

15. The device according to claim 12, wherein a cleaning device is arranged in front of the device for hydrogen separation or in front of a device for conducting a water gas shift reaction, in which undesired constituents are separable from the intermediate product.

16. The device according to claim 12, wherein the pyrolysis device is comprised of a thermal drying device, in which a gas fraction and a largely water-free solid matter fraction is produceable from the starting material, wherein glycerin present in the gas fraction is at least partially pyrolyzed due to temperatures prevailing in the thermal drying device.

17. The device according to claim 12, wherein the pyrolysis device includes a cleaning device and a downstream pyrolysis reactor, wherein a pyrolysis feedstock is produceable in the cleaning device from the starting material by separation of impurities, which is transformable into the intermediate product by pyrolysis in the pyrolysis reactor.

18. The device according to claim 17, wherein the cleaning device is a vacuum distillation device and/or a thermal drying device and/or a filtering device with active charcoal or a membrane and/or a chromatography device and/or an ion exchanger.

19. The device according to claim 12, further comprising a device for reducing a water content of an aqueous waste generated during a cleaning of the starting material containing glycerin.
